(19) United States
(12) Patent Application Publication
(10) Pub. No.: US 2003/0096216 A1
(43) Pub. Date: May 22, 2003

(54) Five-gates training program

(76) Inventor: Lynn Nelson Kesselman, Granada Hills, CA (US)

Correspondence Address: Lynn Nelson Kesselman, 10417 Andasol Avenue, Granada Hills, CA, 91344, US

(21) Appl. No.: 10/231,721

(22) Filed: May 14, 2002

Related U.S. Application Data
(60) Provisional application No. 60/292,751, filed on May 18, 2001.

(51) Int. Cl. G09B 19/00

(52) U.S. Cl. 434/236

(57) ABSTRACT

This process causes troubled people with a wide variety of symptoms, such as anxiety, depression, OCD, including addictions, to change their inner belief system in such a way that they become happier, more productive, and lose their cravings for their dysfunctional thoughts and behavior.

This therapeutic training program has five sub-processes called “gates” which are steps to accomplish two goals; to erase the unconscious, negative scripting implanted usually in childhood, and to replace negative or dysfunctional ones offered by this program.

For those with severe problems or disorders a specially trained facilitator is used to guide the client through the five sub-processes, which are actually revelations which the client becomes able to accept in place of their old beliefs.

NAME OF PROCESS; FIVE-GATES TRAINING PROGRAM

NATURE OF PROCESS: A psychotherapeutic treatment technique for permanently and quickly correcting personality dysfunction, relieving anxieties, depression, and addiction cravings. This technique may also be referred to as a structured brief time-limited psychotherapy. Unlike the Five Gates Training Program, other brief time-limited psychotherapy programs commonly in use for these purposes lack structure and rely very heavily on the natural talents and charismatic capabilities of the facilitator.

COPYRIGHT PROVISIONS: The inventor further requests copyright protection on the explanations, unique text and terms incorporated within this application; said items are called out in bold italicized letters.

PURPOSE OF PROCESS: To bring about a corrective and fundamental change in the perspectives of a human being, in his or her view of them self, and the world; specifically this process will substantially relieve the subject client from the harmful effects of learned inaccurate views, which over time caused the dysfunctional aspects of their personality, and causes the client to see them self and the world in a manner that causes the client anxiety, depressions, drives them to compulsive behavior, such as addictions, and even addictions to inaccurate. sometimes morbid thoughts which are depressive and anxiety producing. The five Gates Training enables the individual subject to become capable of living more effectively in present-time, free from the otherwise limiting ingrained perspectives which are at the base of their low self esteem, anxiety, depressions and/or compulsive behavior. This process can often help a person eliminate or substantially reduce their need for psychotropic medications. It has also been effective in reducing or eliminating ADD and self-disfigurement syndrome. It generally installs loving feelings of connections with others and sharply reduces subject's tendencies for sociopathology. This process also has been demonstrated as a tool for reducing or eliminating client's need for psychotropic (mood lifting and balancing) medications. Bipolar diagnosed clients who complete the training successfully almost never experience manic episodes again and can cease taking bi-polar oriented medications which have very severe side effects for many clients.

PROCESS: The program employs the use of a facilitator (“trainer”), who in person or by video, usually also with the support of written materials (see enclosed Forth Gate questionnaire), teaches the subject how a perfectly healthy, sane person, according to the Five Gates philosophy, would think and therefore behave, i.e. beliefs, methods for processing information, actions (see Five Gates Orientation video). Next, the client explores, usually supported by the facilitator, ways in which client processes information or thinks and behaves differently from the ideal method. A key to the effectiveness is to help client see the effect of client's fears in forming client's personality, feelings, and decisions. The facilitation methods are Rogerian (see work of Carl Rogers on optimum counseling techniques, i.e., unjudgmentalness and accepting, loving). This part is called The First Gates Orientation. Which is also called The Mental Awakening.

The client and facilitator proceed by trying together to identify the exact cause(s) of his or her personality, perspectives, symptoms described above in the “PURPOSE OF PROCESS”, and unwanted actions. The goal in this part of the Five Gates Training is to identify how fears and early life misperceptions (to the extent the subject is able to grasp this) are the deep underlying causes of their problems. If the client can see this at this early stage the trainer may share an explanation of the entire process, and how and why it produces the desired result. The subject need not necessarily master or accept all of the ideas presented in the Second Gate and/or The Third Gate in order for the process to work, so long as the subject is sufficiently accepting of the possibility that these ideas are valid and the client is willing to initiate The FOURTH GATE” which is a client created chronology of the events, thoughts and beliefs which together make their personal history and personality (character) inventory (see Five Gates Forth Gate Questionnaire).

These first three “Gates” or philosophical and self-assessment ideas instruct the subject to enunciate, consider, and accept three statements which are repeated and studied further at the conclusion of The Fifth Gate. The first three propositions are:

“FIRST GATE:”—“I have been powerless over something in which has caused me to believe, and therefore to feel, to think, and therefore to do, things in which have diminished my happiness (emotional health).” This statement may be recited by a group in the “we” or plural mode for meetings.

“SECOND GATE:”—“My powerlessness was caused by my wrong beliefs about myself and the world, which (my wrong beliefs) caused my anxieties, depressions, compulsiveness, and my unhappiness, and I don't want to let them run my life anymore”

“THIRD GATE”—“I want to manage my life by better beliefs and methods.” At this point we introduce the subject to a set of “Five Gates REALITY RULES” (see below) which are the subject's acceptance goals for managing the subject's thoughts and lives.

“FOURTH GATE”—“To change my wrong beliefs I must first see how I came to believe them. I can do this by learning my history. At this point the subject is given a questionnaire and instructions by which they will answer questions which will help them record, as much as they are able, the events and circumstances of their lives and the lives of their immediate ancestors, custodians, teachers, peers, authority figures, and other key people from whom they received their beliefs by statements or example (see Five Gates Questionnaire).

“FIFTH GATE”—“I want to be healed from my troubling beliefs (about myself and the world), by seeing with informed adult eyes what I originally misunderstood as a child.” This process is taken with a facilitator (“Five Gates TRAINER”) or by tutorial manuals, recordings and/or other tools which will help the subject see and accept the following:

In the Fifth Gate Process the client and Trainer (facilitator) repeatedly as needed, review client's personal history and the known and inferred histories of those people and circumstances which have affected client, and commit themselves to finding and understanding;

1. The circumstances, ideas, and values under which the client's deepest beliefs and perceptions were formed: certain inferential tools are used for filling in inaccessible memories and history. Contradictions are permissible as long as both conflicting “facts” are believed by the client or client at some time was asked by a credible source to believe facts conflicting with client's beliefs then or now. Only those which must be reconciled to bring about the results described here are contested and must be reconciled with logical facts, with the illogical ones intently examined and discarded. Missing memories are considered very important here, often hiding the causes of trauma, and they are filled in by reasoning through the changes in the client's beliefs and feelings contrasting them before and after the missing memory segments.

2. The resulting inaccurate or dysfunctional beliefs and/or compulsive habits that were created earlier in the subject's life. often reinforced later by subsequent events. Each dysfunctional belief and/or action must be identified as stemming from one or more events of information and/or experience received and believed in the client's history record. It is the trainer's job to facilitate this identification process where the client cannot, and help the client see its effects on client clearly before completing the Fifth Gate process.

3. How the subject's personality and as the result client's life might have been very different had the beliefs and circumstances to which they had been subjected been different.

4. How the client can now change their views and actions and thereby themselves and their lives.

The Fifth Gate Process proceeds with the following additional revelations.

As client sees him or her self as the product of the circumstances that have operated upon client, client accepts that client deserve forgiveness (not to be judged irrevocably inadequate or flawed as a human being) for client's wrong ideas and/or behavior. Granting forgiveness to oneself in the sense of the Five Gates philosophy means to accept that one has always intended to do what seemed at the time, and at all times, logical given client's beliefs at that time, and/or were compelling beyond client's conscious control at that time. This insight is necessary in order for client to believe that they can change their beliefs, making them more realistic and enlightened, and that this will change their lives in positive, desired ways.

The trainer provides to client many of the needed insights of how client can make these changes in themselves and thereby their lives.

The subject can by the same means granted to themselves, now grant the same unjudgmental perspective toward all people, past, present and future. This has the effect of freeing them from the bondage of their resentments and irrational fears towards others. This creates in client a freedom from the past and ability to focus fully in present time, which triggers an effect we call the “Spiritual Awakening” of the client. This is why the Forth Gate and the Fifth Gate are called the “Spiritual Awakening.”

The “Mental Awakening (first three Gates), and The Spiritual Awakening, together are called “The Five Gates Core Training.”

The subject is also taught to see that he or she will forever be the product of their accurate or inaccurate beliefs and wisdom and therefore the subject should expect to make errors of judgment and choices, but that the subject should not judge him or herself or others under any circumstances, but instead strive to learn more and make decisions that lead to insights and actions which will always be subject to review and change where possible. A saying which the Five-Gates Program uses to help clients understand this idea is, “Everyone is always perfect at being exactly who they are (at that moment).”

The subject at this point is ready to intellectually accept and to some degree employ the insight that “Everything always was, is and always will be exactly as it should be,” based on a more mature understanding of cause and effect as it operates in their lives and the lives of others. Another important way to see the importance and validity of this “Spirituality” granting perspective is that it does us no good to see this as otherwise. A number of conceptual sayings (see below) are used to affix these ideas in the minds of clients in order to facilitate more functional insights and decisions after the “CORF TRAINING” (the name given to the process of the first Five Gates).

The result of this process, (FIVE-GATES CORE TRAINING) which when supplemented by one or more post core training meetings is called the “Five-Gates Program,” which results in a lessening of personality (perceptions) based anxieties, reduction of depressiveness, reduction of the inner-stresses which drive compulsive behavior, addictions, and cravings. The Five Gates Training has even resulted in lessening of, or ending of attention deficit disorder and self mutilation syndromes. A further insight revealed by this process and its effects is that wrong beliefs are in themselves all addiction resulting in any or all of the above maladies and unhappy feelings and/or dysfunctionalities. The efficacy rate for this process, “Five-Gates Training Program” has been proven to far exceed any other training or psychotherapeutic methods now in use.

FIVE-GATES REALITY RULES

1. We must give up our superstitions, things we believe without sufficient evidence, in order to process our reality effectively.

2. Everything works according to cause and effect but we will never know all the causes or all the effects, but we accept that our only job in life is to “do the next right thing to our best ability, to know it, do it, enjoy it, and learn from its results.” We therefore accept that we cannot change the past nor can we change many other things about reality, therefore it is our job to accept what we cannot change, including the past and present but focus ourselves on using our wisdom and power for managing ourselves in the present to try to bring about a future we desire.

3. Only the things we can do can possibly be our job; therefore what I cannot do cannot be my job; e.g., we cannot change the past or know the future, or control anyone, just try to manage ourselves the best we can at the time we are in (present).

4. The world acts as a mirror of my attitudes and actions; when I am positive, the world tends to be or seem positive in response to me and when I'm negative my world will seem negative to me. My attitudes create my reality.

5. Since we reject superstition, we believe in cause and effect and accept that everyone has some degree of ignorance, and therefore the world is made up of natural laws, and the intentions and the wisdom of the people in it.

6. We accept that only positive thoughts and actions are enlightened and that deep down everyone knows this, therefore we accept that everyone is doing their best at all times to do what they at that time believe is positive as they see it. For this reason, we do not judge people as human beings but only measure and try to predict their ideas and actions as a reflection of their beliefs and emotional condition.

7. Since it serves no useful purpose to believe otherwise, we accept that everything was, is and always will be exactly as it is supposed to be.

8. Guilt and shame serve no useful purpose and contradict healthy thinking. Therefore secrets, based in guilt and shame, are a measure of our dysfunctional beliefs.

9. Co-dependency is the degree to which we defer the use of our own ability to evaluate situations ourselves, accepting instead someone else's perceptions in place of our own. Co-dependency is the usual cause of the inaccurate beliefs that cause (d) most of our problems. They are the single greatest cause for our need to take the Five-Gates Program's training.

10. An infant is born more naked than simply having no clothing, but is born also with no wisdom (the knowledge of the effects of actions in the world) and is aware of this limitation, which is why early in life we tend to be co-dependent. The lessening of our co-dependence is the maturation process by which we accept the responsibility to think and learn for ourselves. The Five-Gates Program training accelerates the process of maturation by helping us remove our fears concerning our ability to accurately process information and therefore helps us overcome the fear of taking responsibility for our own thoughts and actions.

11. We don't know how good our recovery is until it's not good enough anymore. This is why we must always monitor ourselves for correct perceptions and actions, even when we're confident we're doing very well in our recovery.

12. The presumptions of judgmentalness (our believing that someone or something isn't now the way it is supposed to be now), are the basis of our resentments, which are the basis of many of our most disabling dysfunctionalities.

13. Our world is a mirror of us, reflecting back at us our positive and negative attitudes and actions.

14. No love is wasted if only to make me a loving person.

15. Others don't deserve our loving them, we do.

16. We are much more alike than we are unalike, but were mistakenly raised to look for our differences from other and encouraged to judge ourselves and others. If we want spiritual/emotional freedom and happiness, we must learn to stop judging people.

17. Lynnisms; The following (in addition to all the italicized items above) are slogans and insights unique to the Five Gates Training Program and copyrights for them is hereby requested;

My limitations are not my shortcomings. Nothing I can't do can possibly be my job. What I think, say and do is about me, what you say, what you think and what you do is about you, even if you say it's about me. My recovering has not failed yet just because it has not succeeded yet. I never know how good my recovery is until it's not good enough. I have the power to love you or like you no matter what you do or think about me. I will always try to love everyone for my sake, not theirs. The world is a mirror of me. I am connected to everything and everyone and they are connected to me. I don't know if you're supposed to drink or use other drugs or behave in other ways, I'm only trying to manage myself well, and help you do the same. As your trainer, my job is to help you gain more power. People who feel empowered do not intentionally bring suffering upon others but instead tend to be loving and generous. The greatest gift I can give you is to help you experience being who you most love to be.

Our bottom is always exactly in the place where we believe that continuing to use is immediately more painful to us than the hoped for relief of stopping. It's never based upon what I think will happen later. It's never based on what is the morally right thing to do. If I cared about that, I wouldn't have fallen into the pit of spiritual bankruptcy. We all have some faith in something or we would be driven mad by our fears. We intuitively believe the sun will rise in the morning and the laws of gravity will continue to operate upon us so we won't fly off this planet. But do we believe that we can have a secure and pleasurable life? It is the restoration of that faith that is our real recovery. Once we have that, the steps to wellness are easy to take. “I seek to turn my will and my life over to the care of God's principles as I understand them.” “To a grasshopper, all people look alike”

I have no idea if you're supposed to drink or use other drugs or behave in other ways. I only know it's my wish and my intention to help you be so happy without needing to full back on any compulsive behavior that you will have the truest maximum degree of personal power of choice and clarity that I can help you achieve. What you believe about use of this new power is entirely up to you. People who feel empowered do not intentionally bring suffering upon others but instead tend to be loving and generous. The greatest gift I can give you is to help you experience being the ‘you’ most love to be. We all go through life trying to overcome our lack of self-knowledge-to know ourselves is the greatest step towards understanding others.

1. Five Gates Training Program (the claimed intellectual property) is a psychotherapeutic treatment technique for more permanently and more quickly correcting personality dysfunction, relieving anxieties, depression, substance and behavior addictions, and/or OCD (Obsessive-Compulsive Disorder.) This technique may also be referred to as a structured brief time-limited psychotherapy.

2. We also claim the exclusive use of the name “Five Gates” as a trademark and copyrighted designation for any psychotherapeutic or self-help psychologically-based therapy or training program.

3. We also claim the exclusive use of the term “structured brief time-limited psychotherapy,” and the exclusive use of the special unique terms written in italics in the Written Specification for the Five Gates Training Program.
